(19) United States
(12) Patent Application Publication
(10) Pub. No.: US 2025/0165632 A1
(43) Pub. Date: May 22, 2025

(54) DATA SECURITY SYSTEMS FOR CONTROLLING ACCESS TO RESTRICTED DATA AND DATA PROCESSING FLOWS TO PREVENT COMPROMISING DATA AND FLOW ABUSES

(71) Applicant: PAYPAL, INC., San Jose, CA (US)

(72) Inventors: Sreeram Vasudevan, Singapore (SG); Vipul Jain, Singapore (SG); Ranjith Kumar Paramasivam, Singapore (SG); George Chen Kaidi, Singapore (SG)

(21) Appl. No.: 18/513,048

(22) Filed: Nov. 17, 2023

(51) Int. Cl. G06F 21/62

(52) U.S. Cl. CPC G06F 21/6218

(57) ABSTRACT

There are provided systems and methods for data security systems for controlling access to restricted data and data processing flows to prevent comprising data and flow abuses. A service provider, such as an electronic transaction processor for digital transactions, may provide a restricted access controller and dynamic permission calculator to enforce more granular and dynamic permissions of data access and restricted such access to prevent unauthorized access through flow abuse. To prevent malicious actors from circumventing required authorizations to data, the restricted access controller may provide permissions for data based on the particular data portion and elements, which may be determined based on the context of the data when entering the system or when requested by users. Further, permissions may be dynamically calculated when users request data instead of static permissions, which may be based on the flow, such as how the user arrives at the data being requested.

### TECHNICAL FIELD

The present application generally relates to data security systems for online digital platforms and more particularly to controlling access to restricted data and data processing flows using dynamic permissions and risk assessments.

### BACKGROUND

Online service providers may offer various services to end users, merchants, and other entities. This may include providing electronic transaction processing data flows, services, and other computing resources. Users may utilize a computing device to access and utilize different processes, operations, applications, and platforms of the service provider available over the network, as well as request processing of data. As hackers and other malicious users or entities become more sophisticated, they may perform different computing attacks and other malicious conduct against the service provider. For example, fraudsters may attempt to compromise sensitive data, or attempt to perform fraudulent electronic transaction processing or account takeover. Service providers may thus utilize security and risk detection systems to identify suspicious behavior and malicious activities and then take action to mitigate or prevent such behavior and activities. However, as computing attacks become more sophisticated, fraudsters and malicious actors find different ways to compromise systems. Service providers may have different navigation flows to data that may each have different authorizations and/or authentications. Malicious parties may identify and navigate certain pathways or request data that circumvent required authorizations. Current systems may assume that actors utilizing these applications and/or requesting the data when arriving on a page may have authorization, but those may have been bypassed by malicious actors. As such, when malicious activities are not quickly and/or correctly identified, service providers may not be able to take desired (e.g., timely and/or specific) actions to mitigate or prevent such malicious activities. Thus, it is desirable for service providers to quickly determine dynamic permissions to data to reduce risk, data exfiltration, fraud, and potential damage or exposure of data.

### BRIEF DESCRIPTION OF THE DRAWINGS

FIG. 1 is a block diagram of a networked system suitable for implementing the processes described herein, according to an embodiment;

FIGS. 2A-2C are exemplary diagrams of state-based protections for a restricted data access control system that protects from flow abuses, according to an embodiment;

FIGS. 3A-3D are exemplary diagrams for a restricted data access control system that prevents flow abuses and unauthorized access to data, according to an embodiment;

FIG. 4 is a flowchart for data security systems for controlling access to restricted data and data processing flows to prevent comprising data and flow abuses, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for data security systems for controlling access to restricted data and data processing flows to prevent comprising data and flow abuses. Systems suitable for practicing methods of the present disclosure are also provided. Note that while various examples, structures, techniques, etc. may be described with respect to a service provider in this specification, these structures, techniques, etc. are generalizeable and are applicable to any entity that uses restricted data access policies and permissions according to various embodiments.

In an entity's (e.g., service provider's) systems, such as online platforms and systems that allow users to interact with, use, and request data processing, the service provider may provide a computing architecture that may face different types of computing attacks coming from malicious sources over a network. For example, a malicious actor may initiate a computing attack on the computing environment of the service provider, such as an HTTP smuggling request, denial-of-service (DoS) and distributed denial-of-service (DDoS) attacks, a fraudulent transaction processing request, a password attack, a web abuse (e.g., account enumeration, brute-force attacks, SQL injection), or other type of computing attack. These computing attacks may introduce risk to resources of the service provider, secure and sensitive data, and/or fraud and loss by the service provider or users of the service provider. More recently, malicious actors and other users have attempted to breach various computing systems and restricted data by circumventing security layers and required authorizations for permissions to access data, content, and/or computing resources (e.g., applications, databases, data, operations, networks, etc.). These parties attempt to find vulnerabilities or weaknesses in particular permission and restricted data policies for data authorizations and restricted data access and navigate to data when not authorized.

For example, conventional security systems may work on an assumed trust that a client will only request data when necessary. However, there may be multiple layers between the system involved in a data access, such as the authorization system to access the data and the resource owner (e.g., that controller of the data store). Thus, conventional systems authorize access to data at an application level, but have insufficient checks to ensure that all layers who receive access are actually allowed to have it. Further, malicious actors may use toolkits that attempt large scale bypassing of authorizations to view pages, page views, data, interfaces and interface data, and the like. There may be multiple ways (e.g., navigation pathways, processes, authentications, etc.) to access a page and data, and some may have less required authentications and identity validation or be unintended. Thus, by identifying improper flows to pages and data, malicious actors may compromise service provider systems, applications, and data.

To prevent from flow abuses, the service provider may utilize a dynamic permission calculator and state-based protection that implements permissions and authorizations for page and/or data access per request and/or in real-time when data is requested. In this regard, the system for protecting restricted data access and flow abuses may dynamically calculate permissions for users, devices, and other requestors of data at a time of arriving on a page and/or requesting data on the page, where such data may have a restricted access control to the data that requires a permission and therefore authorization, identity validation, authentication or the like to access the data. Each page may have a corresponding dynamic and calculated permissions requirement(s) for data and content on the page, which may be broken down into page elements and/or combinations of page elements. Pages may generally correspond to webpages and/or interfaces of a software application, where page elements may refer to the individual data elements on each page (e.g., a field, menu, informational box of section, navigational option, video/audio, etc.). The permissions may be dynamic instead of static such that a calculation is performed when a visitor accesses the page and/or requests data for the visitor's required authorizations and the dynamic permissions of the data on the page for that particular visitor. The dynamic permissions may then be enforced by requiring the user to have the corresponding required authorizations and/or perform the required authentications and/or identity validations. As such, a more granular approach may be provided at each page to prevent from flow abuses that may utilize static permissions and broad or bypasses authorizations to obtain data unintentionally, illicitly, and/or for fraudulent or malicious purposes.

Additionally, a service provider may implement a restricted data access control and state-based protection system to detect, minimize, and/or prevent unauthorized data access and navigation or processing flow abuses. This system may be used identify, remedy, stop, and/or prevent these computing attacks and other abuses of the service providers. In this regard, the restricted data access control may provide components to intercept and detect data as the data enters the service provider system. The system may operate to classify and mask data when entering the system, where different chunks or parts of the data may be assigned different classification levels. This allows for data to be provided based on their dynamic data classifier when a page is accessed and/or data is requested. Further, a central authorization engine may configure and maintain access classes of pages, which may allow for permissions for data on pages to be dynamically processed for providing data to clients based on the client's identity and/or past actions and authorizations leading up to the data request. Thus, a data access controller and plane may be implemented to enforce more granular and dynamic permissions for restricted data on request from users, devices, or the like, which may be computed per request.

In this regard, a service provider may provide services to users including electronic transaction processing such as online transaction processors (e.g., PayPal®), which may allow merchants, users, and other entities to process transactions. Other service providers may also provide computing services, including social networking, microblogging, media sharing, messaging, business and consumer platforms, etc. To use these services, a user may wish to create an online digital account, engage in digital account usage and/or electronic transaction processing, and/or process a purchase of one or more items in a transaction. Selection of one or more items during an online transaction with a merchant may require a payment instrument from the user for electronic transaction processing. A user may pay for one or more transactions using a digital wallet or other account with an online service provider or transaction processor (e.g., PAYPAL®), as well as the payment card (e.g., through proffering the physical card and reading card data or by entering card details and/or account numbers). An account and/or corresponding payment card with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or financial investments, which may be used to process transactions for items. However, the account creation may be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant. However, computing attacks, malicious and fraudulent behavior, and the like may compromise the security of digital accounts and corresponding data including financial and personal data. This may incur, risk, loss, and fraud to the user of the account and the service provider providing the account to the user, such as by bad and malicious actors using the aforementioned computing attacks, toolkits, and the like. As such, the service provider may implement a more robust a comprehensive restricted data access control and state-based protection from different data access and flow abuses.

To protect from flow abuses, the service provider may implement a state enforcer that provides a baseline data protection and restricted access control to data on pages, as well as a dynamic permission calculator to dynamically change or calculate permissions on a per data request basis. For a baseline, the state enforcer may capture the highest level of authentication and authorization required for a flow between pages and/or to arrive at a page and corresponding data, as well as the client's, user's, or device's highest level of authorization that has been validated. This baseline may be enforced and required for a minimum required defense from circumventing required authorizations and authentications when navigating or proceeding through a flow to a page. Further, a dynamic permissions calculator may dynamically calculate permission requirements of a page when a client and/or device arrives at the page and/or requests data, which may allow permissions to be defined to the page and/or data on the page dynamically based on the flow and journey of the client/device instead of statically assigned to the page that may be circumvented through particular flows.

The dynamic permission calculator may utilize different parameters and information, such as all authentications obtained by the client and/or device during the flow and the level of authentication or authorization scores. The parameters may further include all obtained or provided authorizations during the flow, actions and a risk score of overall actions taken on the page and/or during the flow, and/or the page flow itself (e.g., the series of steps taken and/or pages navigated through to arrive at the page and request the data). A multi-dimension score array, such as of different authorization scores to access data, may be provided and processed for the dynamic permissions that provides a granularity of checks for access to data and allow assigning dynamically calculated permissions to the page and/or data on the page. The dynamic permissions may be calculated, and a risk score based on the user/client/device's identity and other data may be determined. Such permissions and risk or authorization scores may be compared for providing data that has restricted access controls. Different “locks” may be implemented that correspond to different flows from these dynamic permissions, where the risk “lock” for permissions on the page may be required to meet a “key” generated from the user's risk score.

In order to dynamically calculate these permissions and/or “locks” for pages, a simulation-based validation of abuse identification may be performed by simulating unique pathways for the varying sequence of steps, pages, and/or authorization states that clients may take to arrive at the corresponding page, such as simulation of unique pathways based on real traffic. This may be used to determine the different parameters and varying restrictions to data (e.g., access controls and required permissions) for the page based on those sequences of steps and/or pages. The service provider may therefore identify vulnerabilities in application programming interface (API) access or authentication controls implemented on data for pages based on different flows of steps performed and/or pages navigated. These vulnerabilities may correspond to security gaps in permissions and coverage of permissions implemented on data access, such as to restrict data access to certain data and/or on certain pages. As such, sequences of steps may be identified as suspicious or tied to fraud, which may be simulated to detect if there could be abuse, such as if there is a security gap in permissions and their coverage of restricted data. If so, these steps may be added to a block list or restricted, or additional security steps may be implemented for restricted access controls to prevent abuse.

The service provider system may implement the restricted data access controller and/or system using a data classification and management component, a control plane inspector component, and a central authorization decision engine. These three main components may be utilized to assign dynamic classifications and permissions on a more granular basis to data on pages (e.g., webpages of a browsable website or interfaces of a software application). Data classification and management may be performed as data enters the service provider system, where it may be intercepted in structured or unstructured form. A context may be derived from the data, such as whether input may be classified as restricted or sensitive (e.g., an address may be restricted if needed for a user's location but may not be restricted if obtaining aggregates of users in an area). Such context may utilize an intelligent context derivation system and/or models, such as one or more ML models that derive context from language, semantics, and syntax in data, as well as context to the data (e.g., how the data enters the system, such as a data submission route). The data that is sensitive may then be masked and a feedback loop may be implemented to learn and improve on data classification (e.g., sensitive or restricted or not, as well as level of data classification. Such masking may be implemented on multiple levels and/or for different authorizations.

Thereafter a control plane inspector (CPI) component may consider the data that is obtained from the dynamic data classification based on context, and may utilize tags or identifiers for classification levels to map data access restrictions and/or restricted access controls to the data on different pages where the data appears, is loaded, or may be requested by clients and users. The central authorization decision engine may provide information for the page access level, such as the authorizations that should be present and required for presentation of data on the page, as well as the required data access authorizations and classes for the data. In this regard, the CPI may utilize a blockchain protocol and distributed ledger to create smart contracts that contain rules corresponding to the contents of the page and permissions required to access the content (e.g., authorizations that need to be processed and/or obtained by clients for those permissions). This may be computed by collating the identifiers or tags for data classifications levels for the data on the page and the overall page authorization level. The identifiers may be stored on the blockchain in a blockchain record so that when a user and/or client requests to access data or other contents on or in a page, the smart contracts verify the permission identifiers and the authorization and/or identity of the user/client for rendering of such data. The central authorization engine may be utilized to enforce such smart contracts and provide rendering in real-time and on a per user and/or request basis to implement the restricted data policies around the pages and data in a more secure and granular manner.

As such, the service provider may provide a dynamic and secure approach to data permissions and access controls through a security system that may provide more granular and specific controls to data privacy and security. This system provides faster, more efficient, and more secure restricted data security and flow abuse prevention. As such, online digital platforms and computing systems are improved when providing restricted access controls to data that are managed by permissions required by clients when requesting data. This is done through the use of a restricted access controller with dynamically calculated permissions in a more granular and per-request basis for pages and data. This further reduces the burden of individual request review while reducing time-consuming tasks of identifying computing attacks and data access or flow abuses, thereby reducing system resource costs for data security.

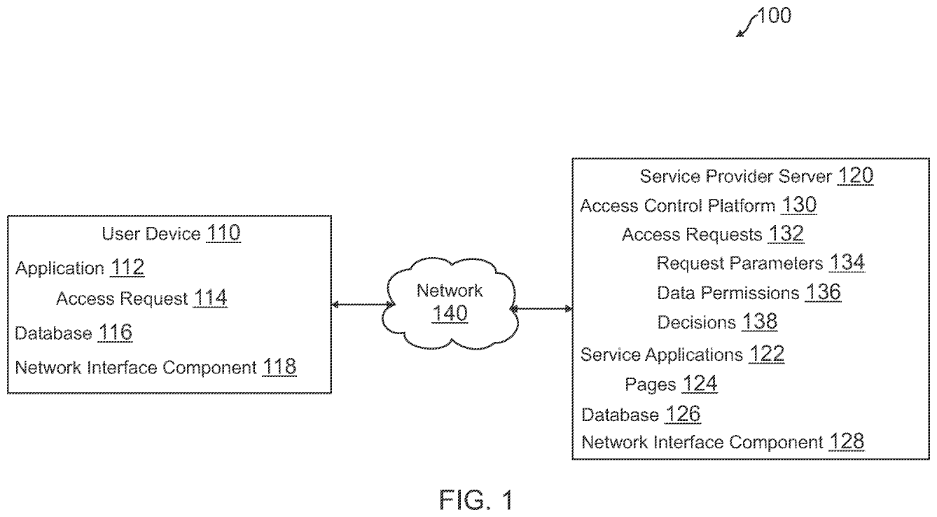

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a user device 110 and a service provider server 120 in communication over a network 140. User device 110 may be utilized by a user over network 140, where service provider server 120 may provide various data, operations, and other functions to user device 110 via network 140. In this regard, user device 110 may execute an operation to navigate to a page of service provider server 120, such as a webpage, user interface, or the like that provides data via one or more fields, components, or operations. Service provider server 120 may provide a restricted access controller that implements granular and dynamic permissions to data, which may depend on a flow of how user device 110 arrives at the page and/or requests the data.

User device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

User device 110 may be implemented as a communication device that may utilize appropriate hardware and software configured for wired and/or wireless communication with service provider server 120. For example, in one embodiment, user device 110 may be implemented as a personal computer (PC), a smart phone, laptop/tablet computer, wristwatch with appropriate computer hardware resources, eyeglasses with appropriate computer hardware (e.g., GOOGLE GLASS @), other type of wearable computing device, implantable communication devices, and/or other types of computing devices capable of transmitting and/or receiving data. Although only one device is shown, a plurality of devices may function similarly and/or be connected to provide the functionalities described herein.

User device 110 of FIG. 1 contains an application 112, a database 116, and a network interface component 118. Application 112 may correspond to executable processes, procedures, and/or applications with associated hardware. In other embodiments, user device 110 may include additional or different modules having specialized hardware and/or software as required.

Application 112 may correspond to one or more processes to execute software modules and associated components of user device 110 to provide features, services, and other operations for a user over network 140, which may include accessing and/or interacting with service provider server 120. In this regard, application 112 may correspond to specialized software utilized by a user of user device 110 that may be used to access a website or UI provided by service provider server 120 to perform actions or operations. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information (e.g., a website for a merchant), presenting the website information to the user, and/or communicating information to the website. However, in other embodiments, application 112 may include a dedicated application of service provider server 120 or other entity (e.g., a merchant).

Application 112 may be associated with account information, user financial information, and/or transaction histories. However, in further embodiments, different services may be provided via application 112, including messaging, social networking, media posting or sharing, microblogging, data browsing and searching, online shopping, and other services available through service provider server 120. Thus, application 112 may also correspond to different service applications and the like that are associated with service provider server 120.

When using application 112, a bad actor may execute a computing attack or automated script (e.g., using a toolkit or the like) to perform some operation to compromise service provider server 120 and/or conduct fraud, such as by performing an access request 114 to data that user device is not authorized to obtain or view. However, not all uses, and in some cases none of the uses, of user device 110 and application 112 may be malicious. In some embodiments, application 112 may further be compromised, such as by one or more security issues that perform automated attacks and/or compromise data unintentionally but unknown to users. In further embodiments, executable scripts may be executed with application 112, which may automate some function to perform computing attacks and/or malicious or fraudulent data and navigation flows to circumvent restricted access controls and required permissions to access pages and data with access request 114. Thus, application 112 may be used to attempt to discover secret or sensitive information (e.g., passwords, answers to security questions, login credentials, social security number, credit/debit card information, bank account information, and any other data the user and/or the service provider would not want publicly available) by performing access request 114 during an unauthorized flow to a page and/or page data that is barred by the rules and regulations of service provider server 120.

In response to the attempted access to unauthorized data by user device 110 via application 112, service provider server 120 may implement one or more remedial actions and/or alerts with user device 110. Remedial actions may include blocking user device 110 and/or a corresponding device identifier or fingerprint, user information, location, IP address, application identifier or fingerprint, or the like. This may cause the attempted unauthorized access to stop, halt, or repair the damage performed by application 112 with service provider server 120. In some embodiments, an alert may be generated and provided to application 112 by service provider server 120, which may be output to the corresponding user. Service provider server 120 may also implement a restricted access control system with granular and dynamic permissions to pages and data, as discussed herein, to further protect from flow abuses and data compromise.

User device 110 may further include database 116 stored on a transitory and/or non-transitory memory of user device 110, which may store various applications and data and be utilized during execution of various modules of user device 110. Database 116 may include, for example, identifiers such as operating system registry entries, cookies associated with application 112 and/or other applications, identifiers associated with hardware of user device 110, or other appropriate identifiers, such as identifiers used for payment/user/device authentication or identification, which may be communicated as identifying the user/user device 110 to service provider server 120.

User device 110 includes at least one network interface component 118 adapted to communicate with service provider server 120 and/or other devices, servers, and endpoints. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide operations for restricted access controls through granular data permissions on pages and dynamic permission calculation. In this regard, service provider server 120 includes one or more processing applications which may be configured to interact with user device 110 to detect whether user device 110 is authorized to access a page and/or data, such as during a flow through steps and/or pages of service provider server 120, and provide or restrict access to such data in a granular and dynamic manner on pages. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes service applications 122, an access control platform 130, a database 126, and a network interface component 128. Service applications 122 and access control platform 130 may correspond to executable processes, procedures, and/or applications with associated hardware. In other embodiments, service provider server 120 may include additional or different modules having specialized hardware and/or software as required.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may include a transaction processing application that may be used by users associated with user device 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service applications 122. The digital accounts may be accessed and/or used through one or more instances of a web browser application and/or dedicated software application executed by user device 110 and engage in computing services provided by service applications 122. Computing services of service applications 122 may also or instead correspond to messaging, social networking, media posting or sharing, microblogging, data browsing and searching, online shopping, and other services available through service provider server 120. Such computing services may be provided via pages 124, such as browsable webpages of one or more websites and/or application page data that may be loaded to one or more interfaces of a software application (e.g., mobile or other device application, rich Internet application, etc.).

In various embodiments, service applications 122 may be desired in particular embodiments to provide features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider server 120 via one or more of user device 110, where the user or other users may interact with the GUI to view and communicate information more easily. In various embodiments, service applications 122 may include additional connection and/or communication applications, which may be utilized to communicate information to over network 140.

Additionally, service applications 122 may be used to provide a service or other information to one or more users or accounts based on restricted access controls and permissions to data on pages 124. In this regard, service applications 122 may be managed and/or interact with access control platform 130 to provide data granularly depending on the data and/or context of the data, as well as dynamically based on real-time or per-request calculated permissions. Access control platform 130 may correspond to one or more processes to execute modules and associated specialized hardware of service provider server 120 to provide a platform and framework to detect and protect against unauthorized data access requests by enforcing access restrictions and controls, as well and determine dynamic permissions for enforcing such restrictions and controls. In this regard, access control platform 130 may correspond to specialized hardware and/or software used by service provider server 120 to receive and process access requests 132, such as access request 114 from user device 110. Access control platform 130 may then process access requests 132 based on request parameters 134 that are associated with the flow of user device 110 to the page and/or data being requests with data permissions 136 to yield decisions 138, such as based on risk assessments, scores, and the like.

In this regard, access control platform 130 may initially establish data permissions 136, such as when data enters a system and/or environment for service provider server 120. Data permissions 136 may be dynamic and changed, updated, and/or calculated in real-time and/or on a per-request basis for access requests 132. In this regard, access requests 132 may be accompanied by request parameters 134, which may indicate how access requests 132 were made, the flow or path that user device 110 and/or other devices, clients, or the like arrived at a page and made access requests 132, and/or other authorization, authentication, and/of validity data from past events and actions taken by such devices and clients. A state-based protector may enforce state-based decisions (e.g., based on a current authorization state of a processing and/or navigation flow), which may include a minimum required authorization and dynamic permissions for authorization to access and/or view data. Request parameters 134 may therefore include identity data and the like for the corresponding client or device, such as user device 110. A risk engine (e.g., rule or ML model-based) may then compute a risk assessment and/or score, where decisions 138 may be executed to provide or restrict access to data.

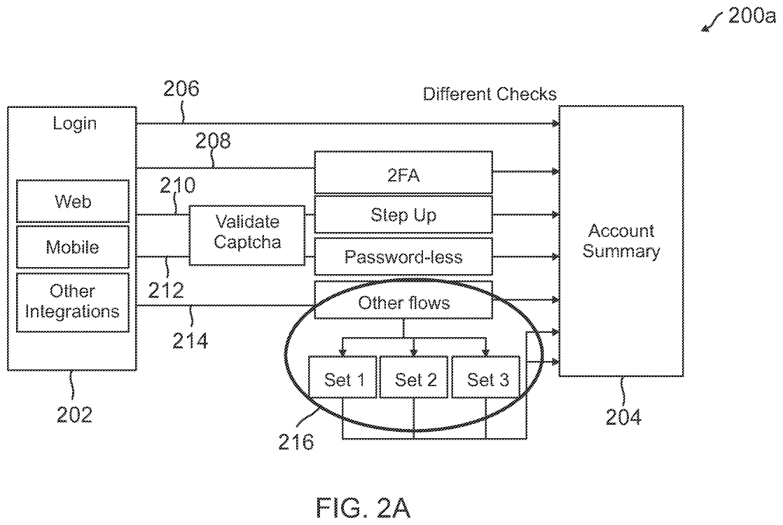

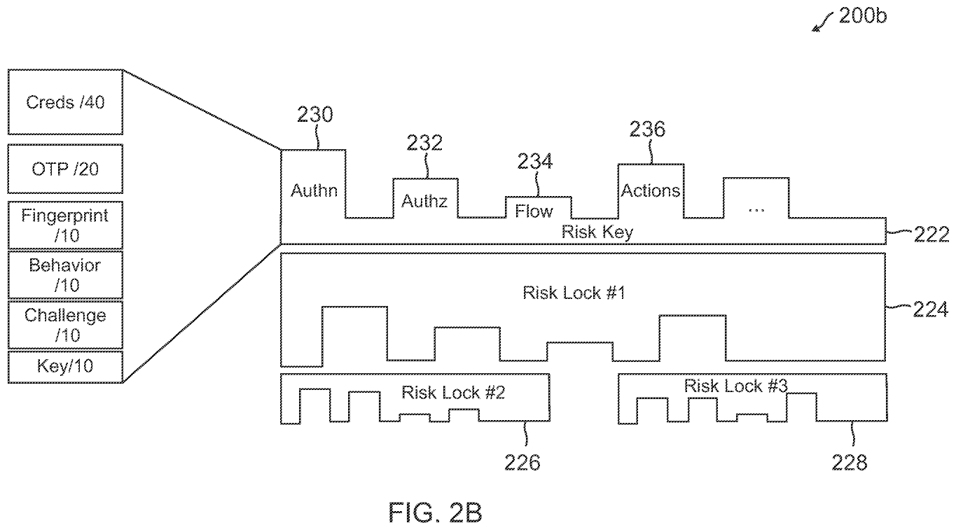

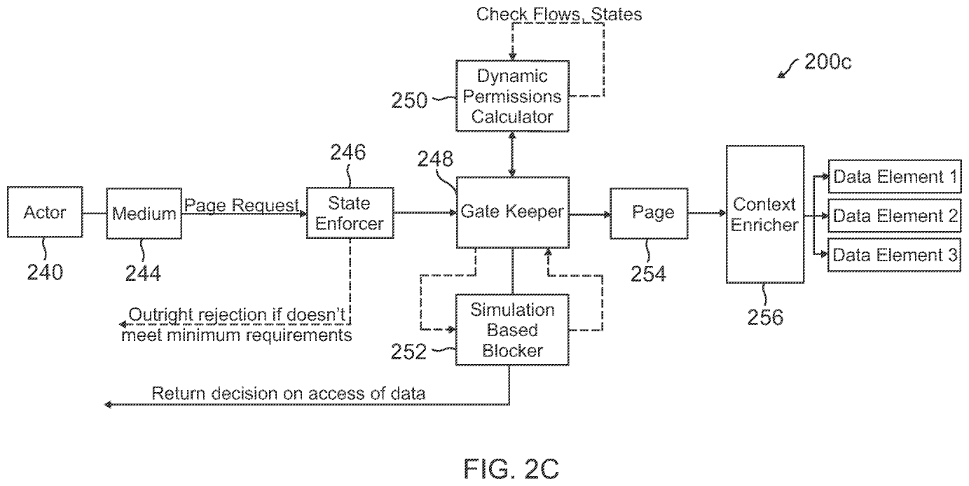

Managing data permission 136 may be performed using a restricted access controller, which may include components for data classification and management, control plane inspection, and a central authorization decision engine. Data may be classified as sensitive or restricted, as well as a corresponding authorization level, in a granular manner depending on the data and not the data object, file, or the like as a whole. Further, classification may be based on context of the data entering the system and/or usage, and the data's classification level may be stored with the data. Pages may also have classification levels and/or restrictions assigned by the central authorization decision engine as a whole, where the data presented on the page may be permitted when such authorization is validated or obtained by a requestor device or client. The control plane inspector may utilize a blockchain and corresponding distributed ledger of records to persist the classifications for pages and data to one or more records as smart contracts that may be enforceable on a page visit. As such, data permissions 136 may initially be loaded from one or more smart contracts for processing of access requests 132. The components, operations, and processes of access control platform 130 are described in further detail below with regard to FIGS. 2A-4.

Additionally, service provider server 120 includes a database 126. Database 126 may store various identifiers associated with user device 110. Database 126 may also store account data, including payment instruments and authentication credentials, as well as transaction processing histories and data for processed transactions. Database 126 may store financial information or other data generated and stored by other applications 122. This may include data from one or more operations provided by other applications 122, including access requests 132 and access request 114 from user device 110.

In various embodiments, service provider server 120 includes at least one network interface component 128 adapted to communicate user device 110 over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2C are exemplary diagrams 200a-200c of state-based protections for a restricted data access control system that protects from flow abuses, according to an embodiment. Diagram 200a includes a representation of different flows and corresponding authorizations that may be performed by a device when proceeding through steps to arrive at a page and/or request data, which may be performed between user device 110 and service provider server 120 discussed in reference to system 100 of FIG. 1. In this regard, a client 202, such as one executed by user device 110 in system 100, may be on an account summary page 204, such as a page provided by service provider server 120 in system 100, where client 202 may request access to data (e.g., view financial or account data, change a password, process an electronic transaction, etc.).

In diagram 200a, client 202 may include different endpoints and/or applications for APIs that have integrations with the pages and endpoints of service provider server 120 for arriving at account summary 204 during a flow, such as a web-based API and application, mobile API and application, or the like. Client 202 may perform a login 206, which provides a first authentication, and may further before additional authentications that receive corresponding authorizations for data access, such as based on data class. This may include a 2-factor authentication 208, a step-up authentication 210, a password-less authentication 212 (e.g., Captcha-based authentication), or other flows 214 having different sets of authentications during steps and navigations to arrive at account summary 204.

As such, there may be many flows that allow client 202 to arrive at the page for account summary 204, each of which has a corresponding set of security and authorizations. For example, a user with a limited account or an account that has been flagged may need to perform additional authentications, such as 2-factor authentication 208, step-up authentication 210, etc. Each of these steps would have a corresponding authorization state for the user, such as the verification and authorizations, which has parameters that may be associated with a risk score or assessment. However, certain flows may bypass one or more of authentications 206-216 or other verifications and, as such, require dynamic permission calculation and enforcement to prevent flow abuses and data compromise.

Referring now to FIG. 2B, in diagram 200b, an exemplary “lock” and “key” structure for dynamic permissions is shown that may be enforced with client 202 when accessing the page for account summary 204 in diagram 200a, where permissions may be calculated dynamically (e.g., in real-time and/or on a per-request basis) for client 202. In this regard, a key 222 is shown that is based on the corresponding flow and data parameters for the flow, such as identity, past actions or activities during the flow, authentication and authorizations, and the like. Key 222 may then be compared to locks 224, 226, and 228, to “unlock” or authorize data access by complying with such dynamically calculated permissions. As such, access to a page and/or data on a page may be permitted for a restricted access control when the permissions in locks 224, 226, and 228 are met by key 222.

For example, key 222 may be composed of different parameters that may indicate and identity and corresponding risk or potential fraud assessment of the client, device, and/or user attempting access to the page and/or data requiring permissions in one of locks 224, 226 and/or 228 to be met. These parameters may include authentications 230, authorizations 232, a flow 234, and actions 236. Key 222 may be dynamically and uniquely determined and computed for the client, device, and/or user on arriving at the corresponding page and/or requesting the data, and locks 224, 226, and 228 may correspond to different dynamic permissions that may also be dynamically calculated depending on the authorization state prior to and at the time of the request. Locks 224, 226, and 228 may also be based on simulations of unique pathways leading up to the page and/or data. For example, the service provider may simulate and test different unique pathways by devices and/or perform traversals of paths to identify such paths. In some embodiments, these pathways may be detected as a result of a past or previous data breach of data that occurred as a result of use of a toolkit to perform a computing attack. The service provider may determine the authorizations and other activities that occur in such navigation paths and/or navigation pathways, and may customize locks 224, 226, and 228 to correspondingly require certain permissions and requirements are met due to those paths. When comparing, if a match is determined, data access may be permitted. However, without a match, one or more additional operations may be performed to block access to the data, remedy potential data breaches and/or flow abuses, notify system administrators and/or users of the flow abuse, and the like.

Referring now to FIG. 2C, in diagram 200c, an overall diagram for enforcing dynamic permissions when an actor 242, such as one using user device 110 from system 100, interacts via a medium 244 to request data. For example, actor 242 may use medium 244 to submit a page request to a state enforcer 246. State enforcer 246 may enforce a minimum requirement for page access and/or data viewing, which may provide an outright rejection if the minimum is not met. Thereafter, a gate keeper 248 may be used with a dynamic permissions calculator 250 and simulation-based block 252. Gate keeper 248 may restrict access to data, or conversely permit access, based on dynamically calculated permissions by dynamic permissions calculator 250 that checks flows and flow states for corresponding permissions required to access data. Thereafter, simulation-based block 252 may simulate the flow and flows for other unique pathways, previously or in real-time, to identify any potential authorization circumvention and flow abuses, where a decision on an access to data may be returned. Such a decision may be based on a risk assessment or the like from the identity, states, and the like of actor 242 and the dynamic permissions determined by dynamic permissions calculator 250. The risk assessment may further be based on whether there is an indication of a previous data breach, such as of data security to restricted data by an unauthorized entity, which may have resulted from use of a toolkit during a computing attack. Additionally, the risk assessment may be computed based on a similarity of the page flow and/or other actions of actor 242 prior to and/or when requesting the data to a past or previous computing attack and/or previous data breach identified by the system, such as on using a toolkit identified as used by fraudsters. The similarity may be a similarity score of the detected actions during the current data request and those actions taken during the previous computing attack or data breach.

Thereafter, access to data on a page 254 may be determined and provided by gate keeper 248. Page 254 may be returned to actor 242 via medium 244 so that data may be viewed and/or accessed on page 254. Further, a context enricher 256 may be implemented to provide additional context enrichment decisions to access to data on page 254 for particular data elements, and therefore whether those data elements should be presented based on the context in which they are being requested. For example, where an address is requested, the context to sensitivity may be important, such as whether during a billing information request or a more general population or demographic determination. As such, context enricher may allow for data elements to have multiple classifications and each data element may be provided or restricted based on the context in which is it requested.

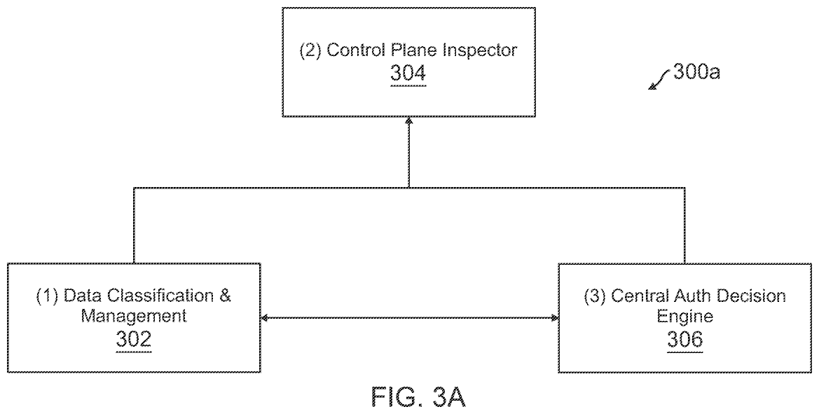

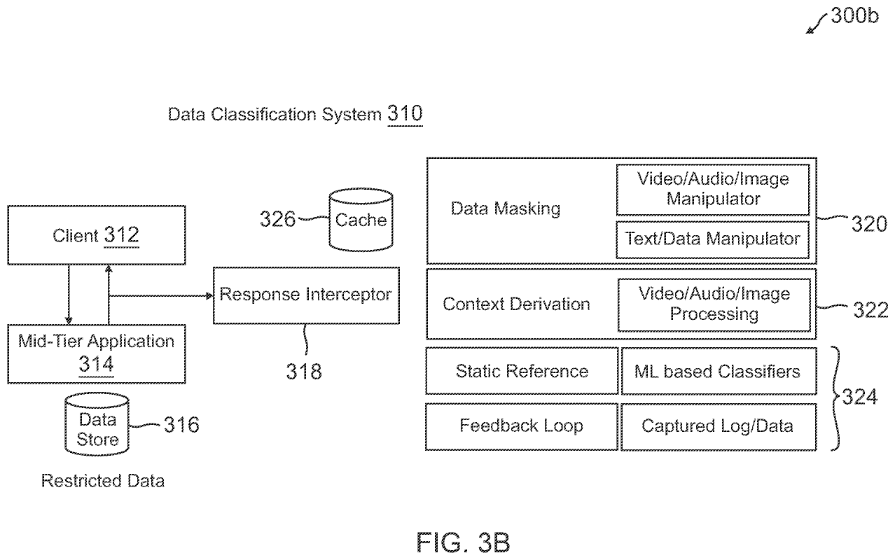

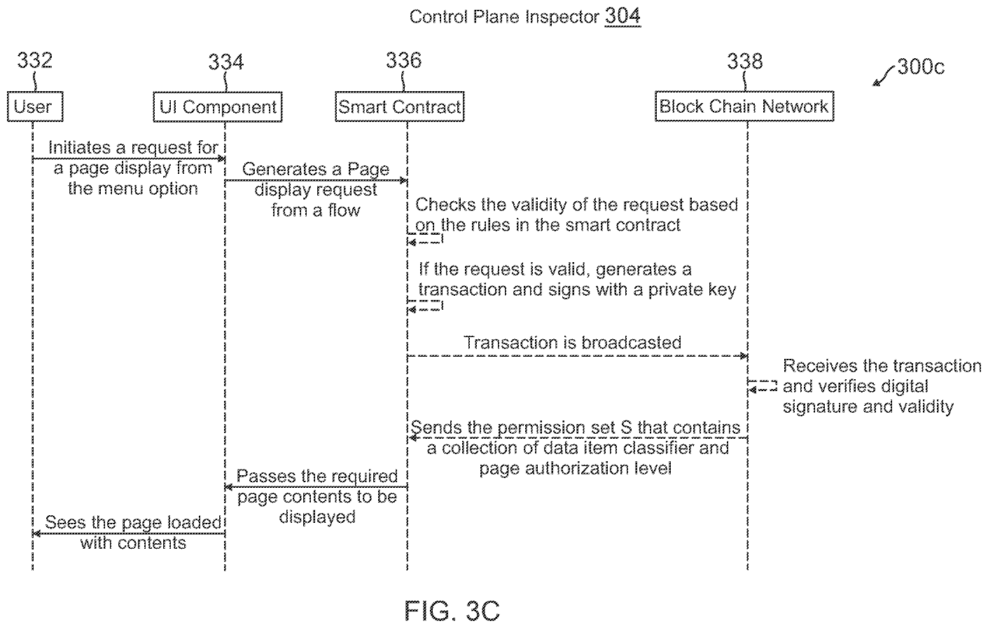

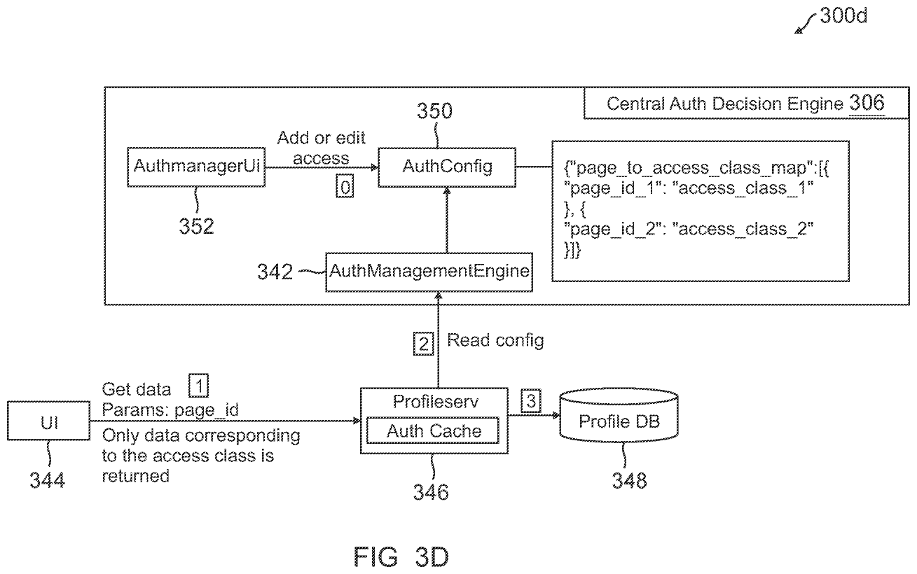

FIGS. 3A-3D are exemplary diagrams 300a-300d for a restricted data access control system that prevents flow abuses and unauthorized access to data, according to an embodiment. Diagram 300a of FIG. 3A includes a representation of a restricted access control system and platform having corresponding components used for classifying data on a granular level based on data context, which may be performed by access control platform 130 of service provider server 120 in system 100 of FIG. 1. Thus, the components may be used for establishing different permissions for data classifications on pages and to the data itself when requested by devices, such as user device 110 in system 100.

In this regard, diagram 300a includes data classification and management 302, a control plane inspector 304, and a central authorization engine 306 corresponding to the components and processes of the system and platform for creating and enforcing restricted access controls on data based on permissions to the data. Diagram 300a includes three components, however, more, different, or less components may be used for generating and enforcing permissions to access data during different flows and/or based on different authorizations granted to devices, clients or the like. Data classification and management 302, control plane inspector 304, and central authorization engine 306 are each described in further detail below with regard to diagrams 300b-300d of FIGS. 3B-3D.

For example, diagram 300b of FIG. 3B includes a data classification system corresponding to data classification and management 302. In diagram 300b, data classification system 310 may interact with a client 312 through a mid-tier application 314, where a data store 316 may provide data that is entered to the service provider's system and/or platform for processing and use with various pages and the like (e.g., webpages, application interface data, etc.). As such, mid-tier application 314 may provide an access point to provide data that is classified to data classification system 310 by client device 312 and/or from data store 316. A response interceptor 318 provides the component to detect and/or intercept data entering the system and designate the data for restricted access control classification and/or sensitivity determination.

Data classification system 310 may then process the data to provide data classifying and masking based on context of the data, which be based on how the data enters the system and may be enforced on a granular level depending on the specific portions of the data that has been intercepted. In this regard, data may be assigned different classifications, which may require different permissions for access on a page. These may be enforced on a granular basis for the particular data portions and/or components, as well as the page and/or field for data display on the page. Data masking 320 may then perform data masking of sensitive, redacted, or restricted data, which may use a video/audio/image manipulator and/or text/data manipulator to mask the data, data object, and/or file. This may be based on context derivation 322, which may include text-based analysis (e.g., semantics, syntax, usage, etc.) with video/audio/image processing. Additional components 324 may also be used for classifying data, which may be access and/or utilized depending on the data and/or system requirements. For example, additional components 324 may include static references in the data, a feedback loop, ML-based classifiers, and/or captured logs/data for the client or device. Data classification system 310 may then output masked data having tags or identifiers for the masked data that may allow providing the masked data based on meeting an authorization for a classification level of the data (e.g., satisfying a permission). These permissions and other page and data level authorization requirements may be configured by control plane inspector 304 to configure.

Referring now to FIG. 3C, in diagram 300c, operations of control plane inspector 304 are shown with regard to a user 332 that requests data that has been classified by data classification system 310 in diagram 300b of FIG. 3B. In this regard, user 332 may enter and proceed through a flow of steps, navigations, pages, and/or authorizations or verification checks to arrive at a page, where user 332 then initiates a request for a page display from a UI component 334, such as through a menu option. UI component 334 generates a page display request from the flow, which is provided to a smart contract 336 for execution and processing by control plane inspector 304 depending on the permissions of the page and/or data.

Smart contract 336 may then check the validity of the request based on the rules in the smart contract, and if valid, may generate a transaction for data processing on a blockchain network 338 (e.g., as a transaction record for processing, verifying, and persisting on the blockchain, such as in a record for a distributed ledger). If the request is valid, smart contract 336 and/or control plane inspector 304 may sign that transaction using a private key and the transaction is broadcasted on blockchain network 338. Blockchain network 338 may then receive the transaction and verify the digital signature and validity. Thereafter, blockchain network 338 may send the permission set that contains a collection of data item classifiers and page authorization levels to smart contract 336. Smart contract 336 may use this permission set to pass the require page data and contents to be displayed to UI component 334, which may be based on the available authorization(s) of user 332. UI component 334 may then provide this page content and data to user 332 for display, where the page is loaded for viewing by user 332.

Referring now to FIG. 3D, in diagram 300d, central authorization decision engine 306 is shown for returning data to users based on granular permissions for pages and page contents having the data requested by the users. An authorization management engine 342 may handle requests from a user interface (UI) 344, where UI 344 may access an interface and provide request parameters for the request to access data, such as a page identifier, device identifier, and the like. This may be provided to a profile server 346 that profiles the device using a profile database 348 to determine authorizations obtained by the device accessing UI 344, which may be cached and provided to authorization management engine 342. Authorization management engine 342 may then determine a risk score or other risk assessment for the request to access the data based on the profile or other identity of the device, the data parameters for the request, and page access classifications or levels having permissions required to access the data. Authorization management engine may determine and execute such decisions using an authorization configuration 350, which may include the data classifications and permissions. Further, an authorization manager UI 352 may also be provided to allow for adding or editing access to particular data, which may occur before, after, or during requests.

As such, the service provider system and corresponding restricted access controller including data classification and management 302, control plane inspector 304, and central authorization engine 306 may receive and process an access request to data by a requestor device via a page of the service provider system, where the page includes one of a webpage or an application interface and presents the data via one of a webpage element on the webpage or an interface element of the application interface. In other embodiments, it may be determined that the data has a restricted access control to the data with the service provider system, where the restricted access control comprises one or more permissions associated with a presentation of the data via at least the page. Further, an identity associated with the requestor device of the data and a page authorization level of the page may be determined, and using or based on the identity and the page authorization level, a risk assessment of the access request via the page by the requestor device may be determined. Thereafter, a decision on providing the data to the requestor device via the page may be executed based on the risk assessment.

The data may be associated with financial information of a user of the requestor device via the page and includes multiple classes of data being presented on the page, and the one or more permissions may be based on at least one of a previous designation of the data, a data security and restricted data policy that limits or enforces permissions on data access, or a simulation of data usage during page navigations. Before or prior to receiving the request, the service provider system and restricted access controller may intercept the data prior to a storage by a data storage system of the service provider system, derive a context associated with the data and one or more future presentments of the data via the page or other pages of the service provider system, and masking the data based on the derived context. Deriving the context may include performing a data classification of one or more of a text, an image, a video, or an audio of the data using an AI-based system for restricted data content or unrestricted data content.

The data may include a plurality of data chunks each having one of a plurality of data classification levels. Thus, executing the decision may include providing, using a control plane inspector configured to provide the plurality of data chunks based on a plurality of rules for a plurality of webpages established with one or more smart contracts, the data based on the risk assessment and one of the plurality of rules associated with one of the smart contracts for the page. In this regard, the plurality of rules may be managed using a central authorization decision engine for restricted data policies associated with the plurality of data classification levels.

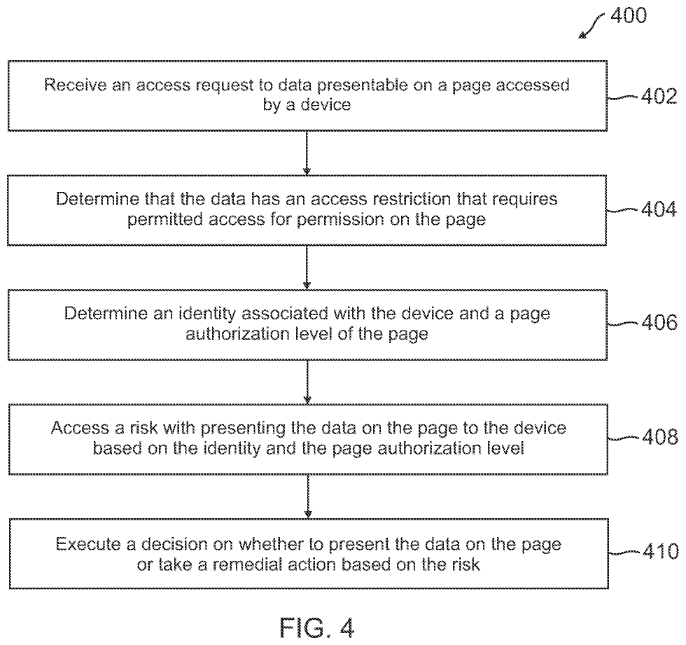

FIG. 4 is a flowchart 400 for data security systems for controlling access to restricted data and data processing flows to prevent comprising data and flow abuses, according to an embodiment. Note that one or more steps, processes, and methods described herein of flowchart 400 may be omitted, performed in a different sequence, or combined as desired or appropriate.

At step 402 of flowchart 400, an access request to data presentable on a page accessed by a device is received. The access request may be received after a series or sequence of steps, navigations, visited pages, or the like are traversed through a page flow (e.g., a series of access and/or navigated between pages) to arrive at the page and/or request the data. However, different page flows may arrive at the same page and/or data that may be requested, which may each have different authorizations, authentications, identity validations, and the like that are performed. As such, malicious users may attempt to fraudulently access data through compromised and/or uncommon page flows that may omit a particular authentication or validation step, and permissions for restricted access controls may not be properly enforced without more granular and per-request processing and risk assessing for the access request. For example, the request may be an account validity check, a credential validity check, a request for sensitive data, a control bypass request, a money transfer, an automation of a custom processing flow or custom flow on the page, or a password change, each which may risk compromising data, account security, and the like if data access control permissions and/or verifications (e.g., identity and/or authentication verifications) are not enforced and/or are bypassed.

At step 404, it is determined that the data has an access restriction that required permitted access for presentation on the page. In order to provide the more granular and per-request, different data on the page that is requested may be identified and corresponding restricted access controls to that data may be determined. Those controls may have corresponding permissions that establish rules for authorizations and/or authentications required for data display and/or provision on the page, as well as interaction with the data. The permissions may be dynamically calculated based on a data source for the data, page data for the page, an authentication performed by a requestor device prior to accessing the page, an authorization received by the requestor device prior to accessing the page, an action taken by the requestor device on the page, or a navigation flow state when accessing the page by the requestor device.

At step 406, an identity associated with the device and page authorization level of the page is determined. The identity of the device may correspond to a client and/or device identifier, as well as any authorizations received by that device, authentication performed, identity checks and/or validations, actions or activities by the device during a flow of steps and/or pages navigated by the device, and the like. The identity may therefore have a corresponding level of authorization or authentication granted by the service provider system for the page, which may then be correlated to the access restrictions and computed with the permissions for data access.

At step 408, a risk with presenting the data on the page to the device is assessed based on the identity and page authorization level. A risk engine, such as a rule-based or ML model-based engine, may compute a risk score for the identity, and thus corresponding authorization level or the like, to have proper authorization and/or be valid (e.g., not malicious or fraudulent) for the data that is requested. Thus, the risk score may attempt to identify whether the data access request is valid for the dynamically calculated permissions enforced on a granular basis for the particular data. At step 410, a decision is executed on whether to present the data on the page or take a remedial action based on the risk. Thus, based on the risk, the access request may be determined to appear valid, and thus data may be provided, or fraudulent, where the data is not provided and additional actions may be taken to secure the data or identify the potential fraudster. The risk may be computed as a factor of the “key” for the device and/or user requesting the data meeting the dynamic “lock” for the page and/or data, thereby allowing access to the data.

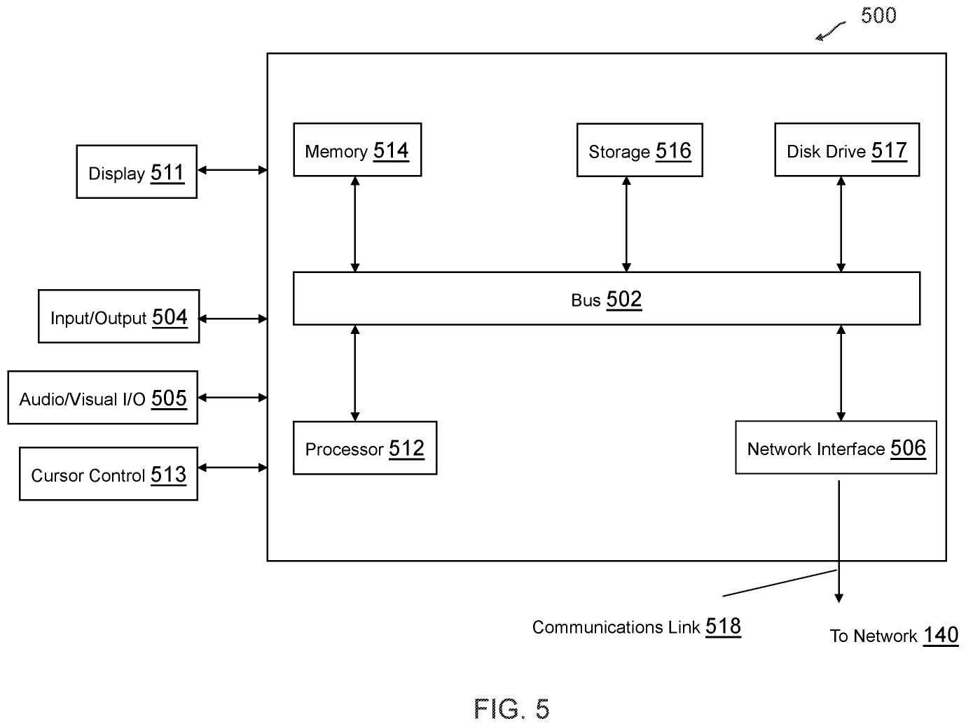

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with network 140. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory storing instructions; and
one or more hardware processors coupled to the non-transitory memory and configured to read the instructions from the non-transitory memory to cause the service provider system to perform operations comprising:
receiving an access request to data by a requestor device via a page of the service provider system, wherein the page comprises one of a webpage or an application interface and presents the data via a data element for the webpage or the application interface;
determining that the data has a restricted access control to the data with the service provider system, wherein the restricted access control is associated with one or more permissions for a presentation of the data via at least the page;
determining an identity of a user associated with the requestor device of the data;
determining a risk assessment of the access request via the page by the requestor device based on the identity and the one or more permissions for the restricted access control; and
executing a decision on providing the data to the requestor device via the data element on the page based on the risk assessment.

2. The service provider system of claim 1, wherein the access request is associated with a navigation to the page in a navigation flow through a plurality of pages, wherein the page includes page elements having one or more restricted data policies requiring an authorization based on the one or more permissions for the page, and wherein the operations further comprise:
dynamically calculating the one or more permissions in response to the navigation to the page by the requestor device based at least one the page elements and one or more the restricted data policies.

3. The service provider system of claim 2, wherein the navigation and the access request are performed through the navigation flow that lowers the authorization from what is required by another navigation flow, and wherein the dynamically calculating includes determining an authorization score for the page elements based on different ones of the restricted data policies for each of the page elements.

4. The service provider system of claim 2, wherein the determining the risk assessment is further based on a plurality of parameters for the page including an action performed by the requestor device during the navigation flow or a page flow through the plurality of pages by the requestor device.

5. The service provider system of claim 2, wherein, prior to the dynamically calculating, the operations further comprise:
simulating a plurality of unique pathways to the page during a plurality of navigation flows that includes the navigation flow; and
determining the restricted data policies for the page elements based on the plurality of unique pathways.

6. The service provider system of claim 1, wherein the access request is associated with one of an account validity check, a credential validity check, a request for sensitive data, a control bypass request, a money transfer, an automation of a custom flow on the page, or a password change.

7. The service provider system of claim 1, wherein, prior to the determining the risk assessment, the operations further comprise:
determining whether the access request includes an indication of a use of a toolkit associated with a previous data breach,
wherein the risk assessment is further based on whether the access request includes the indication of the use of the toolkit.

8. The service provider system of claim 1, wherein prior to the receiving the access request, the operations further comprise:
determining that a page flow to the page bypassed a verification of the requestor device by the service provider system that is associated with the restricted access control,
wherein the risk assessment is determined in response to the determining that the page flow bypassed the verification request.

9. The service provider system of claim 1, wherein the restricted access control comprises one of a plurality of restricted access controls for the page, and wherein each of the plurality of restricted access controls are implemented on a data element level for a plurality of data.

10. The service provider system of claim 1, wherein the operations further comprise:
dynamically computing each of the one or more permissions for the restricted access control when the page is accessed by the requestor device based on at least one of a data source for the data, page data for the page, an authentication performed by the requestor device prior to accessing the page, an authorization received by the requestor device prior to accessing the page, an action taken by the requestor device on the page, or a navigation flow state when accessing the page by the requestor device.

11. A method comprising:
receiving an access request to data for a data element on a page that is accessed by a requestor device, wherein the page comprises one of a webpage or an application interface and presents the data via the data element;
determining page access attributes for the requestor device when accessing the page;
computing, for the access request, a dynamic permission for a restricted access control for the data element based on a calculation of individual data elements associated with the page access attributes, wherein the restricted access control limits access to the data via the data element based on the dynamic permission;
computing a risk assessment of the access request via the page by the requestor device based on the dynamic permission and the requestor device, wherein the risk assessment comprises a multi-dimension score based on the page access attributes; and
executing a decision on providing the data to the requestor device via the data element on the page based on the risk assessment.

12. The method of claim 11, wherein the data element-level calculation utilizes a multi-dimension scoring array that checks the individual data elements based on the page access attributes.

13. The method of claim 12, wherein the page access attributes for the multi-dimension scoring array comprise at least one of authentications by the requestor device prior to accessing the page, authorization states of the requestor device, actions taken by the requestor device on the page, or a page flow to the page by the requestor device.

14. The method of claim 11, further comprising:
computing a similarity to a sequence of steps associated with a computing attack,
wherein the risk assessment is further computed based on the similarity.

15. The method of claim 11, wherein the access request is associated with a navigation to the page in a navigation flow through a plurality of pages, and wherein the dynamic permission is computed in response to the navigation to the page by the requestor device and a comparison of the navigation flow for the navigation to an expected navigation for the requestor device and the access request.

16. The method of claim 11, further comprising:
simulating a plurality of unique pathways to the page during a plurality of navigation flows; and
wherein the dynamic permission is further determined based on the plurality of unique pathways.

17. A non-transitory machine-readable medium having stored thereon machine-readable instructions executable to cause a machine to perform operations comprising:
detecting a requestor device has requested data via a data element on a page of a service provider system, wherein the page comprises one of a webpage or an application interface;
determining a restricted access control to the data via the data element, wherein the restricted access control restricts access to the data via the data element based on a dynamic permission computed at or after a time that the data is requested via the data element;
determining page access attributes for the requestor device when accessing the page;
computing the dynamic permission for the restricted access control for the data element based on data element-level calculation from the page access attributes for an access of the page by the requestor device; and
determining, based on the dynamic permission and the restricted access control, whether to allow the data to be presented on the page via the data element.

18. The non-transitory machine-readable medium of claim 17, wherein the operations further comprise:
simulating a plurality of navigation pathways to the page;
determining a plurality of page access attributes from the plurality of navigation pathways and a plurality of permissions for the restricted access control; and
determining a security gap in the plurality of permissions for the restricted access control based on the plurality of page access attributes and the plurality of permissions,
wherein the dynamic permission is further computed based on the security gap.

19. The non-transitory machine-readable medium of claim 18, wherein, based on the simulating, the operations further comprise:
establishing a state for an access of the page that enforces a permission to block the data present via the data element using the restricted access control based on the security gap and a corresponding one of the plurality of navigation pathways.

20. The non-transitory machine-readable medium of claim 17, wherein the operations further comprise:
determining one or more static permissions for the restricted access control,
wherein the determining whether to allow the data is further based on the one or more static permissions.
